(19) United States
(12) Patent Application Publication
(10) Pub. No.: US 2011/0318085 A1
(43) Pub. Date: Dec. 29, 2011

(54) Dermis Application Device

(76) Inventor: Victor M. Alcocer, Weston, FL (US)

(21) Appl. No.: 12/911,536

(22) Filed: Oct. 25, 2010

Related U.S. Application Data
(60) Provisional application No. 61/358,889, filed on Jun. 26, 2010.

(51) Int. Cl. B43K 5/02; A46B 11/04; A45D 40/04; B43K 5/00

(52) U.S. Cl. 401/143; 401/205; 401/270; 401/68

(57) ABSTRACT

A dermis applicator having a container body and a main tubular volume has one or more applicators attached to a plastic base inserted in the main tubular volume inserted within the container body. A bottom mechanism attached to the main tubular volume rotates through a single circular ridge on the interior surface of the main container body and matching indentation about the vertical upper tube of the bottom mechanism. This bottom mechanism is moveably attached to the main tubular volume through a sliding member passing through an annular stopping location. A spiral groove interior of the bottom mechanism provides a guideway for protrusions from the sliding mechanism that match the spiral groove and make the device move upwards with user rotary action. The applicators themselves are either foam-sponge devices having a refreshing liquid. Alternatively attached to and integrated with another personal care device such as a toothbrush.

### CROSS REFERENCE TO RELATED APPLICATIONS

This application claims priority from provisional application 61/358,889 filed Jun. 26, 2010.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the United States Patent and Trademark Office patent file or records, but otherwise reserves all copyrights whatsoever.

### BACKGROUND

(1) Field of the Invention

This invention relates to improvements in devices for applying substances to the dermis of a human being.

(2) Description of the Related Art

The following represents a sampling of the current techniques available for application of substances to the lips of a human being.

### Current Techniques—Lip Applicator Devices

The top section of FIG. 1 represents three prior art mechanisms for applying different substances to the lips of a human being. Included in the drawing are the main devices themselves and their respective covers. FIG. 1A shows a first item 100 representing a telescoping stick type applicator 100 and cover 110. The stick shown in the drawing extends outwards and is retractable as a result of human interaction with a twisting device; this along with internal components causes the extension and retraction of the applicator stick. In this example, this stick composes the substance to be applied to the lips of a human being. A typical example of the substances that are applied using this mechanism is a decorative lipstick as well as other products that are amenable and stable as a stick.

The next example of an applicator device is shown in FIG. 1B as items 120 and its associated cover 130. In this diagram the gel-like Lip Balm is contained inside of a plastic container similar to a small toothpaste container. The Lip Balm gel is expelled through the user interacting with the container body 120 by compressing the plastic container and thus forcing the substance out from the container. As a result, the gel exits the body of applicator device 120 in a thread like fashion through a small hole at the top of the head of the container.

Another example of an applicator device is the ointment container of FIG. 1C shown as item 140 and its associated cover 150. In this diagram the ointment cream is contained inside of a plastic container similar to a small toothpaste container. The ointment is expelled through the user interacting with the container body 140 by compressing the plastic container and thus forcing the substance out from the container. As a result, the ointment exits the body of applicator device 140 in a thread like fashion through an elongated tube formed at the end of the plastic container and finally through a small hole at the end of the elongated tube of the container. There exist many other examples of lip applicator devices that are made of plastic, metallic and other such materials.

FIG. 1D shows a typical shoe polishing applicator device 160 and its associated cover 170 on the right. This applicator device is used to color a shoe with any one of a variety of colors ranging from white to red to black and many more. The main body of the applicator device is shown as item 160 containing the coloring that is to be applied to a shoe (not shown). At the top of the main container body 160 is the applicator cartridge unit that is inserted into the neck at a hollow circular opening at the top of a tapered shape. The applicator cartridge unit is made up of two main pieces, namely, the collector device and a base plastic device. The collector device is a sponge or foam piece that soaks up the substance contained in main container body of the applicator device. It is of similar size in circumference and diameter as the top of the base plastic device with which it is attached. This attachment is made possible through the use of an adhesive, glue or cement appropriate to these materials.

The applicator cartridge unit locks in place through the use of a circular tongue that runs the circumference of a hollow cylinder at the bottom of the applicator cartridge unit base plastic device. This circular tongue makes a physical lock with one or more ridges internal to the tapered neck of main body applicator device; this lock prevents the applicator cartridge unit from slipping out of the tapered neck that would result in loss of the polishing product. Once locked in this fashion the substance contained in the main body of the shoe applicator device can be poured out by a user through the hollow cylinder integral with the flat plate at the top of the base plastic device; then the coloring passes through an opening in that plate and to the collector device to soak up the coloring for application to a shoe. The shoe polish of FIG. 1 further is made up of several different shapes that the collector device can be made from, namely, a square, a triangle, circular and a heart shape.

Some other examples of applicator devices include the applicator device of FIG. 1F shows a plastic container 180 holding toothpaste alone with its associated cover 190. The cover 190 is threaded using grooves inside the cover to attach to matching threads on the neck of the toothpaste body 180. A final example of a container is an O′ Glue container having a sponge applicator device that is placed atop the applicator's neck and is held in place by mechanical pressure between the neck and the applicator head seal. Thus, the sponge sits atop the neck of the applicator body and is forced through a hole in the applicator head seal so as to dispense glue contained in its body therethrough. The head seal has internal curved grooves that match corresponding grooves or threads on the outside of the neck of the applicator neck. Additionally, there are larger grooves inside of a container cover that match external grooves or threads so as to close the container through the use of the same.

FIG. 2 illustrates devices and usage describing a lip refreshing device. FIG. 2 further has three sub-figures 2A, 2B and 2C representing the general concept of the device, a close-up of the head of the device and an extreme close-up of a bowl having an orifice acting as the mechanism to permit fluid flow into the applicator.

FIG. 2A has a container body 200 made up of a plastic hollow tube and cover 205. The cover 205 when applied to the body of the container 200 hides the main applicator 210 and applicator neck 215. This cover is attached to main container body 200 through the use of threads 220 on the applicator neck 215 that match corresponding grooves on the inside of the cover 205. This main applicator 210 is made from a sponge or foam material and is glued or attached with adhesive to a plastic top of neck 215 that follows the general outline of applicator 210. The applicator itself may take any shape but it is preferred that it be a simple geometric shape such as a circle, square, rectangle, diamond, ellipse or similar regular shape. Finally, the container has an internal reservoir 225 holding a refreshing fluid such as a flavored liquid, balm, mint, cherry, medicine, etctera.

FIG. 2B is an expanded cross-sectional view of the applicator neck 215 region. The foam or sponge applicator 210 sits atop a plastic area of the neck 215 with a depression formed by a bowl 235 formed underneath. This bowl forms a pre-release area so as to moisten the sponge or foam above when a user squeezes and or turns the container upside down. The refreshing liquid held in reservoir 225 flows through an orifice 240 in bowl 235 and towards the applicator 210 so as to moisten it. This bowl thus prevents over moistening of the applicator 210 by continuous application of fluid to the sponge or foam.

FIG. 2C is an extreme blow-up a bowl having an orifice to prevent overflow of the refreshing liquid contained in the reservoir 225. The refreshing liquid held in reservoir 225 flows through an orifice 240 in bowl 235 and towards the applicator 210 so as to moisten it. This bowl thus prevents over moistening of the applicator 210 by continuous application of fluid to the sponge or foam.

FIG. 2D shows a container 250 having an internal reservoir 255 filled with refreshing fluid such as a flavored liquid, balm, mint, cherry, medicine, etctera. A cover 245 closes the entire device through the use of grooves on the inside of cover 245 being screwed onto matching threads external to the neck of the upper portion of container 250.

FIGS. 2E and 2F show a sponge applicator device 270 that is placed atop the applicator's neck 275 and is held in place by mechanical pressure between the neck 275 and the applicator head seal 265. Thus, the sponge sits atop the neck 275 of the applicator body 250 and is forced through a hole in the applicator head seal 265 so as to dispense liquids contained in its reservoir there through. The head seal 265 has internal curved grooves that match corresponding threads 280 on the outside of the neck of the applicator neck. Additionally, there are larger grooves inside of a container cover 245 that match external threads 260 so as to close the container through the use of the same.

### BRIEF SUMMARY OF THE INVENTION

A dermis applicator device having a container body and a main container tubular volume device further having one or more applicator(s) attached to one or more plastic base(s) inserted therein wherein the main container tubular volume is inserted within the container body. The device also has a bottom mechanism attached to the main container tubular volume and to the container body through a single circular ridge on the interior surface of the container body and matching indentation about the vertical upper tube of the bottom mechanism. Further, this bottom mechanism is moveably attached to the main container tubular volume through the use of a sliding member passing through an annular stopping location. A spiral groove in the interior of the bottom mechanism provides a guide-way for a set of protrusions from the sliding mechanism that match the spiral groove and make the device move upwards with rotary action of the bottom mechanism. Of course the applicators themselves are either foam or sponge devices having a refreshing liquid is a flavored liquid from the set of liquids of: a mint flavored liquid, a cherry flavored liquid, a strawberry liquid, a vanilla liquid, a cinnamon liquid, a generic flavored liquid and combinations of the foregoing. This entire system is alternatively attached to and integrated with another personal care device such as a toothbrush or similar item. Optionally, the main container tubular volume device does not have vertical walls instead using the walls of the main container body to hold the dermis applicator(s) and plastic base(s); another optional change is that the main container tubular volume device instead of having solid side(s) has one or more slot(s) running down vertically.

Further, there is taught herein a dermis applicator device having a container body and a reservoir having a refreshing liquid in the container body. Also, the device has an applicator attached to the container body for dispensing the liquid and a second device having a different use attached to the same container body. The dermis applicator device is such that the second device is a set of plastic brushes for a toothbrush or a lipstick with a twist mechanism or a generic personal care device. The applicator is a foam or a sponge device. The refreshing liquid is a flavored liquid from the set of liquids of: a mint flavored liquid, a cherry flavored liquid, a strawberry liquid, a vanilla liquid, a cinnamon liquid, a generic flavored liquid and combinations of the foregoing.

### BRIEF DESCRIPTION OF THE SEVERAL VIEWS OF THE DRAWINGS

FIG. 1 illustrates applicator devices available in the prior art for human lip application, shoe application and toothpaste.

FIG. 2 illustrates a device having a fluid contained inside for the purposes of refreshing a user.

FIG. 3 illustrates several novel devices and usages describing the main principles of a preferred embodiment and several alternative embodiments of the instant invention for dermis application of fluids and creams.

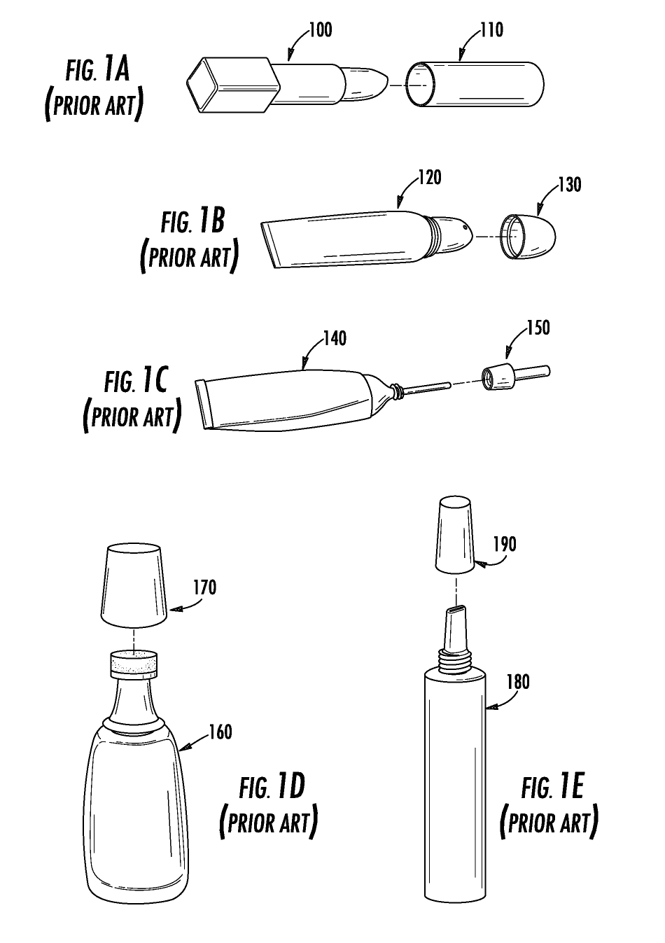

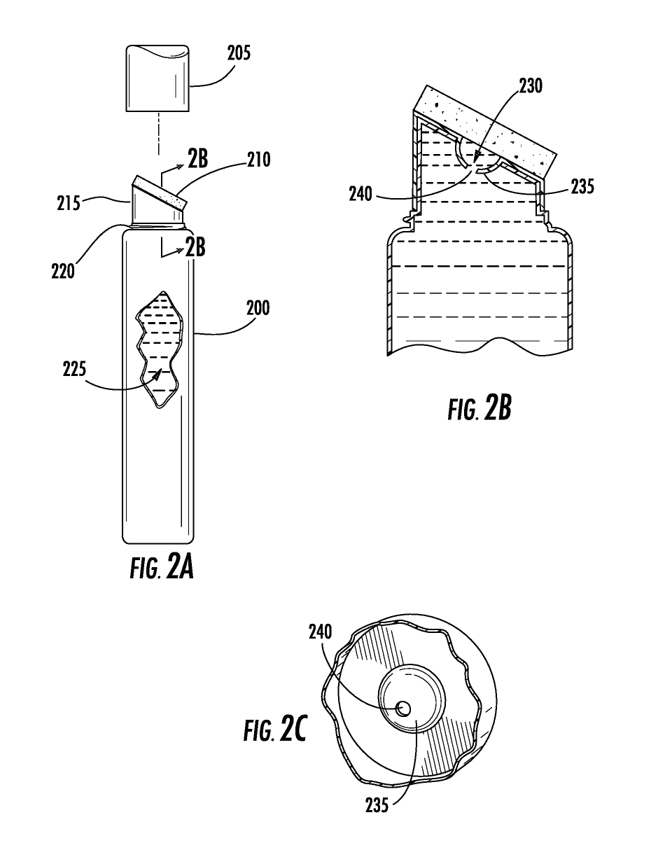

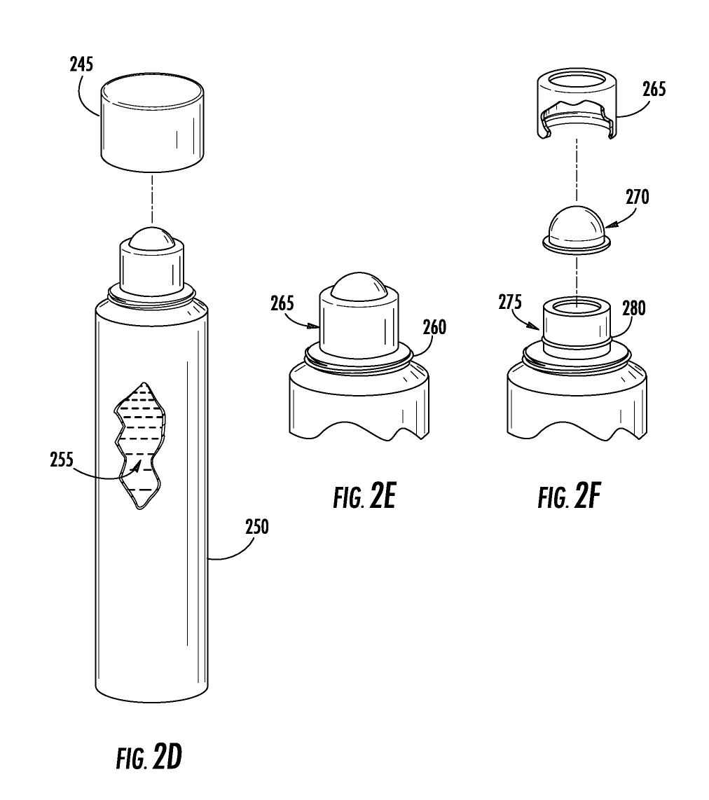

### DETAILED DESCRIPTION OF THE INVENTION

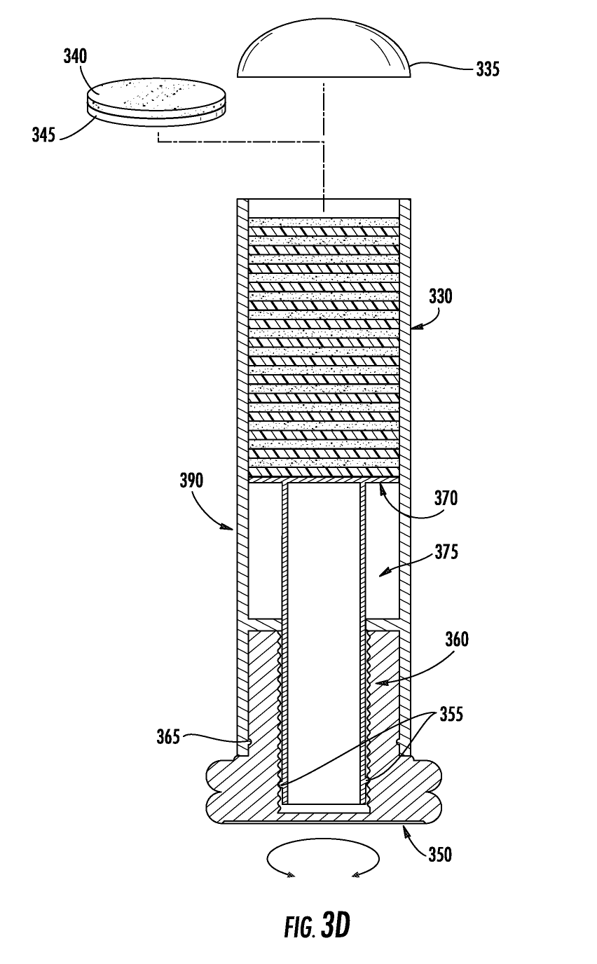

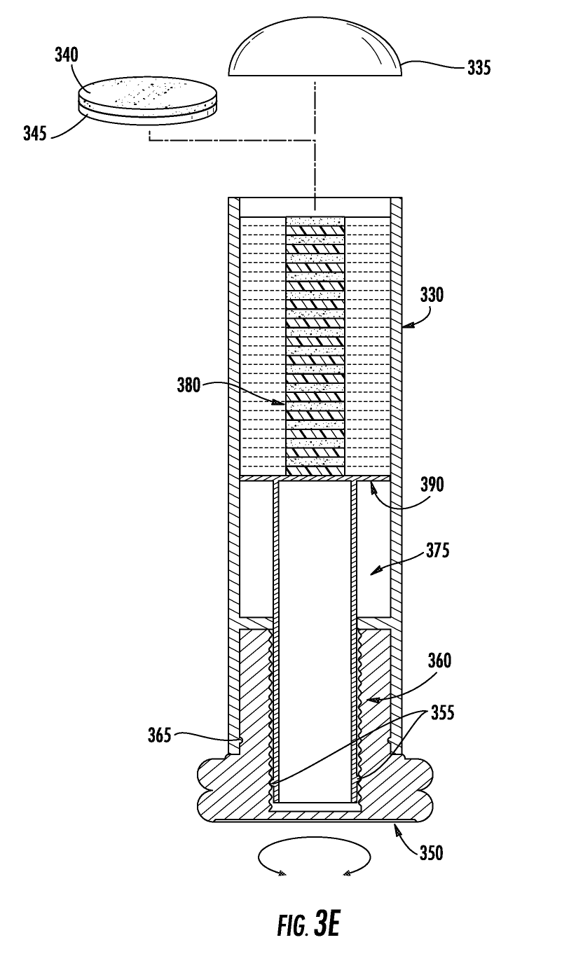

FIGS. 3A, 3B and 3C illustrate several novel devices and usages describing the main principles of alternative embodiments. The first two FIGS. 3A and 3B show combination devices having at least dual uses one of which uses the novelties taught herein of a refreshing liquid such as a flavored liquid, balm, mint, cherry, medicine, etctera.

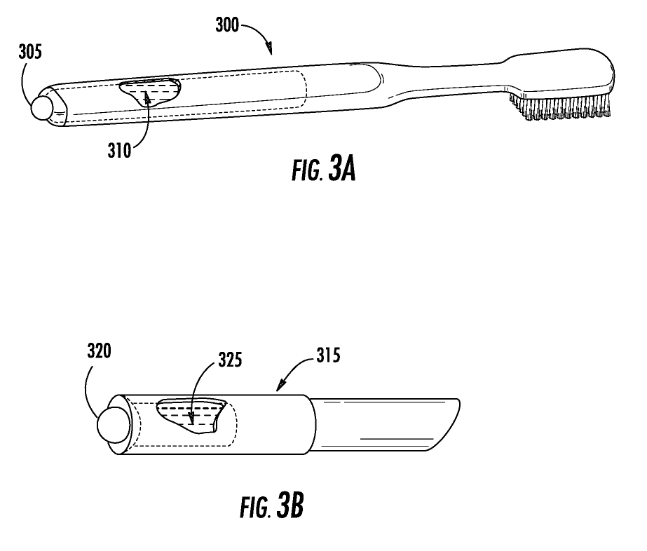

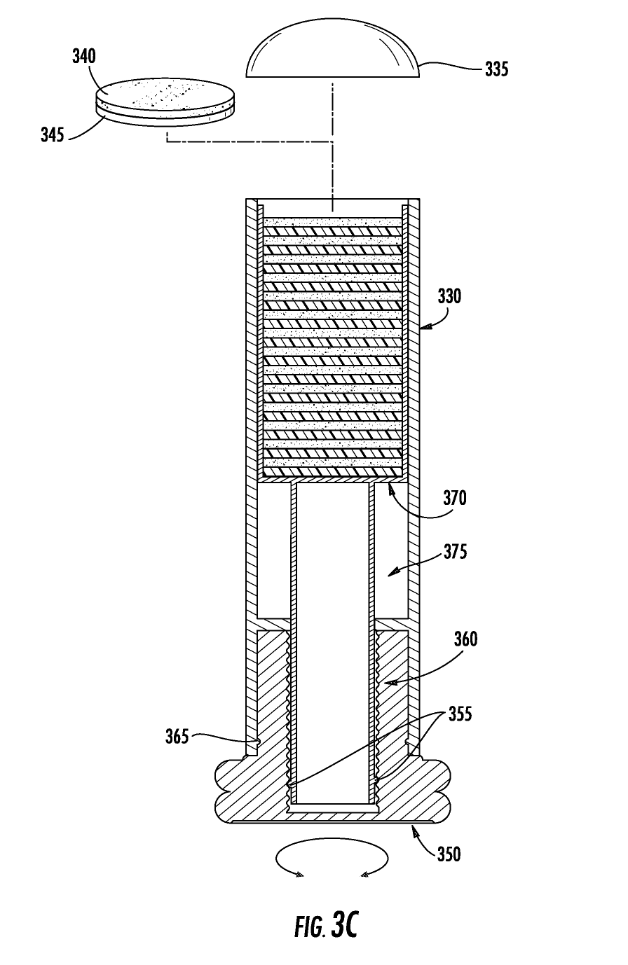

In FIG. 3A is shown an alternative embodiment of a toothbrush 300 having a reservoir 310 filled with the a refreshing fluid such as a flavored liquid, balm, mint, cherry, medicine, etctera at the opposite end of the brush area. A sponge or foam applicator 305, matching grooves/threads and head seal/neck is included as shown previously with regards to FIGS. 2D-2F. The user simply squeezes the sides of the plastic container to force fluid out the sponge or foam tip 305 at the end of the reservoir's 310 container. In the event that the fluid is depleted, the sponge/foam and head seal can be twisted off so as to refill the reservoir 310.

Next, in FIG. 3B is shown an alternative embodiment of a lipstick holder 315 having a reservoir 325 filled with the a refreshing fluid such as a flavored liquid, balm, mint, cherry, medicine, etctera at the opposite end of the stick area. A sponge or foam applicator 320, matching grooves/threads and head seal/neck is included as shown previously with regards to FIGS. 2D-2F. The user simply squeezes the sides of the plastic container to force fluid out the sponge or foam tip 320 at the end of the reservoir's 325 container. In the event that the fluid is depleted, the sponge/foam and head seal can be twisted off so as to refill the reservoir 325.

FIG. 3C shows the preferred embodiment of the novelties taught herein. A Dermis Application Device is shown have a plastic container formed as a hollow tube 330 having multiple mechanisms 340/345 to store refreshing material stored therein. The dispensing plastic container hollow tube 330 has a twisting-type dispenser whereby the rotary action of a plastic bottom mechanism 350 causes the extension or retraction of the plastic dispensing slide 375 having therein the multiple mechanisms 340/345 for refreshment in a main container volume 370 device. Also, there is a plastic cover 335 that has internal grooves on the inside rim of its inner surface that match external threads (not shown) on the neck of the container 330. As previously stated, plastic container hollow tube 330 has multiple mechanisms to store refreshing material within container 330. Multiple foam or sponge applicators 340 are soaked with a refreshing liquid such as a flavored liquid, balm, mint, cherry, medicine, etctera. Each of these foam or sponge applicators is attached to a plastic base 345 through the use of an adhesive or glue so as to provide support and separate each from the next in line. Thus, a user is able to refresh his or her lips by twisting the bottom of the container 350 (with a mechanism identical to a lipstick container) and the foam or sponge applicator at the top of the container 330 exits the top of the container is used by the user and is discarded. The storage of each of the applicators 340 and plastic base 345 is solely by snug physical contact against the inner walls of main container volume device 370 and against the next applicator 340 plastic base 345 inline.

As mentioned previously, the dispensing plastic container hollow tube 330 has a twisting-type dispenser whereby the rotary action of a bottom mechanism 350 causes the extension or retraction of the dispensing slide 375 having therein the multiple mechanisms 340/345 for refreshment in a main container volume device 370. The bottom mechanism is a plastic member having useful multiple curved surfaces for easy gripping. For similar reasons, this member extends outside the region of the hollow tube container 330 such that a user can quickly find 350. It further is made up of a hollow vertical tube integral 360 with the multiple curved surfaces such that the hollow vertical tube extends into the bottom of the hollow tube container 330 until a predetermined stop zone. These are held in place by using two distinct mechanisms. First, item 350 is held with a plastic narrow ridge 365 or protrusion that runs the circumference of or boundary of hollow tube container 330. A hollow indentation in the vertical tube of bottom mechanism 350 that matches the narrow ridge 365 finishes the contact point between hollow tube container 330 and bottom mechanism 350. The second system for holding the devices in place are a set of indentations within the hollow vertical tube of bottom mechanism 350 that extends up until a predetermined stop zone and down past the extreme vertical limit of the external hollow tube container 330 until a bottom stop zone is reached.

These indentations are a long spiral that runs internal to the bottom mechanism in one continuous looping action. Matching this spiral and creating the driving action for the upwards motion of the dispensing slide 375 are plastic tongues 355 made up of at least two plastic pieces that extend out from the external hollow tube dispensing slide 375. This slide is a plastic hollow tube having the two or more tongues on its external surface as mentioned above and runs up through the vertical hollow tube of bottom mechanism 350 through a hole in a flat plastic washer-like predetermined stop zone that extends horizontally and perpendicular to the vertical walls of hollow tube container 330. Finally, main container volume device 370 is a hollow plastic tube having a bottom surface as well as a vertical circular surface integral with the bottom surface so as to form a shape having only one exit namely the top one. It is integral with the dispensing slide hollow plastic container 375 that extends down from the base and or the bottom surface of the main container volume 370 in a tubular shape.

Finally, the mechanisms taught with respect to FIG. 3C are applicable to dual use items such as those found in FIGS. 3A and 3B. The only modifications necessary for these items of course would be the removal of the sponge and head device system used therein, the insertion of the applicators and plastic bases as well as the rotary base, slide (etc) and other items taught with respect to FIG. 3C. In fact, the only major difference between a single use Dermis Application Device and a Dual Use one would be the addition of a narrow ridge similar to item 365 as well as an elongated plastic neck extending out from the bottom side of the bottom mechanism 350 and that sits inside of a cavity in the general mid section of the dual use devices. Of course, this is matched by a hollow indentation to facilitate the twisting action and hold the device in place with the rest of the toothbrush, lipstick etcetera.

Alternative embodiments are shown in FIGS. 3D and 3E for the dermis application device. The container volume device 370 of 3C that was constructed of a tubular member with a bottom portion, curved side and no top for exiting of the refreshment tabs 340/345 is now replaced in two alternative embodiments as follows. First, FIG. 3D shows a device 370 having no external walls so that each applicator 340 and base 345 combination are in physical contact with the inner walls of the tubular member 330. This facilitates the removal of each item when the items 340/345 exit out the top of the container body. Secondly, FIG. 3E shows main container volume 370 being replaced with a tubular container 390 having a slot 380 down one or more locations to facilitate the removal of each item when the items 340/345 exit out the top of the container body. The difference between 3C and 3E is of course that FIG. 3C 370 is indicating a tube that vertically (curved side) and on the bottom encloses the tabs 340/345 and 3E has a slot running down one or more locations on the tubular member 390.

### FINAL CONSIDERATIONS

With the exception of the sponge or foam applicators, the adhesive or glue and the gels or refreshing liquids, all the parts are preferably made up of plastic like pvc or similar material. Alternatively, other man made materials can be substituted based upon the needs of the application. The instant invention has been shown and described herein in what is considered to be the most practical and preferred embodiment. It is recognized, however, that departures may be made there from within the scope of the invention.

I claim:

1. A dermis applicator device:
a container body;
a main container tubular volume having an applicator attached to a base inserted therein wherein the main container tubular volume is inserted within the container body.

2. The dermis applicator device of claim 1, further comprising:
a bottom mechanism attached to the main container tubular volume.

3. The dermis applicator device of claim 2, wherein the bottom mechanism attached to the main container tubular volume is attached through the use of a sliding member moveably attached to the bottom mechanism and the main container body.

4. The dermis applicator device of claim 1, such that the applicator is a foam device.

5. The dermis applicator device of claim 1, such that the applicator is a sponge device.

6. The dermis applicator device of claim 1, such that the refreshing liquid is a flavored liquid.

7. The dermis applicator device of claim 4, such that the flavored liquid is from the set of liquids of: a mint flavored liquid, a cherry flavored liquid, a strawberry liquid, a vanilla liquid, a cinnamon liquid, a generic flavored liquid and combinations of the foregoing.

8. A dermis applicator device:
a container body;
a reservoir having a refreshing liquid in the container body;
an applicator attached to the container body for dispensing the liquid; and a second device having a different use attached to the same container body.

8. The dermis applicator device of claim 7, such that the second device is a set of plastic brushes for a toothbrush.

9. The dermis applicator device of claim 7, such that the second device is lipstick stick and twist mechanism,
and a second device having a different use attached to the same container body.

10. The dermis applicator device of claim 7, such that the second device is a generic personal care device.

11. The dermis applicator device of claim 7, such that the applicator is a foam device.

12. The dermis applicator device of claim 7, such that the applicator is a sponge device.

13. The dermis applicator device of claim 7, such that the refreshing liquid is a flavored liquid.

14. The dermis applicator device of claim 13, such that the flavored liquid is from the set of liquids of: a mint flavored liquid, a cherry flavored liquid, a strawberry liquid, a vanilla liquid, a cinnamon liquid, a generic flavored liquid and combinations of the foregoing.

15. A dermis applicator device:
a container body;
a main container tubular volume within the container body having at least one applicator device within the tubular volume and where the applicator device is attached to a plastic base also inserted therein.

16. The dermis applicator device of claim 15, wherein the main container tubular volume is a tubular device.

17. The dermis applicator device of claim 15, wherein the main container tubular volume is a tubular device having at least one height wise slot.

18. The dermis applicator device of claim 15, wherein the main container tubular volume is comprised of the walls of the container body and a slab of material connected to the sliding member.

19. The dermis applicator device of claim 15, further comprising:
a bottom mechanism attached to the main container tubular volume.

20. The dermis applicator device of claim 19, wherein the bottom mechanism attached to the main container tubular volume is attached through the use of a sliding member moveably attached to the bottom mechanism and the container body.
